(19) United States
(12) Patent Application Publication
(10) Pub. No.: US 2014/0331031 A1
(43) Pub. Date: Nov. 6, 2014

(54) RECONFIGURABLE PROCESSOR HAVING CONSTANT STORAGE REGISTER

(71) Applicant: SAMSUNG ELECTRONICS CO., LTD., Suwon-si (KR)

(72) Inventors: Dong-Kwan SUH, Hwaseong-si (KR); Seok-Jin KIM, Seoul (KR)

(73) Assignee: SAMSUNG ELECTRONICS CO., LTD., Suwon-si (KR)

(21) Appl. No.: 14/269,764

(22) Filed: May 5, 2014

(30) Foreign Application Priority Data
May 3, 2013 (KR) 10-2013-0050248

(51) Int. Cl. G06F 9/30

(52) U.S. Cl. CPC G06F 9/30043; G06F 9/3001
USPC 712/222

(57) ABSTRACT

A reconfigurable processor configured to include a constant storage register to store a constant is provided, thereby improving efficiency in the use of a memory space. Specifically, a reconfigurable processor includes a plurality of Functional Units (FUs), a configuration memory configured to store configuration information, and a constant storage register configured to store a constant that is used as an operand for an operation in the plurality of FUs.

### CROSS-REFERENCE TO RELATED APPLICATION

This application claims the priority from Korean Patent Application No. 10-2013-0050248, filed on May 3, 2013, in the Korean Intellectual Property Office, the disclosure of which is incorporated herein by reference in its entirety.

### BACKGROUND

1. Field

Apparatuses and methods consistent with exemplary embodiments relate to a reconfigurable processor, and more particularly, to a reconfigurable processor having a constant storage register.

2. Description of the Related Art

In a general load-store architecture processor, a constant is transmitted through a register file as an operand or encoded into an immediate operand of an instruction.

In a Coarse-Grained Array (CGA) processor, a constant of each operation is transmitted on a constant field of a register file or a configuration memory. At this point, constants assigned to a configuration memory may usually account for more than 10% of a capacity of the configuration memory. To support floating point constants, a memory space for the constants in the configuration memory may need to be greater than 10%.

### SUMMARY

One or more exemplary embodiments provide a reconfigurable processor including a plurality of Functional Units (FUs), a configuration memory configured to store configuration information, and a constant storage register configured to store a constant that is used as an operand for an operation in the plurality of FUs.

The configuration information may include address information of the constant storage register.

The constant may include a floating point constant.

The constant storage register may be further configured to store a second constant that is used for a predetermined number of times among constants required to execute an application.

According to an aspect of another exemplary embodiment, there is provided a reconfigurable processor including a Coarse Grained Array (CGA) processor configured to process loop operations, a host processor configured to process operations except for the loop operations, and a constant storage register configured to store a constant that is used as an operand for an operation performed in at least one of the CGA processor and the host processor.

The CGA processor may include a plurality of Functional Units (FUs), and a configuration memory configured to store configuration information.

The host processor may be a Very Long Instruction Word (VLIW) processor.

The configuration information may include address information of the constant storage register.

The constant may include a floating point constant.

The constant storage register may be further configured to store a second constant that is used for a predetermined number of times among constants required to execute an application.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a configuration diagram illustrating a reconfigurable processor according to an exemplary embodiment; and

FIG. 2 is a configuration diagram illustrating a reconfigurable processor according to another exemplary embodiment.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Throughout the drawings and the detailed description, unless otherwise described, the same drawing reference numerals will be understood to refer to the same elements, features, and structures. The relative size and depiction of these elements may be exaggerated for clarity, illustration, and convenience.

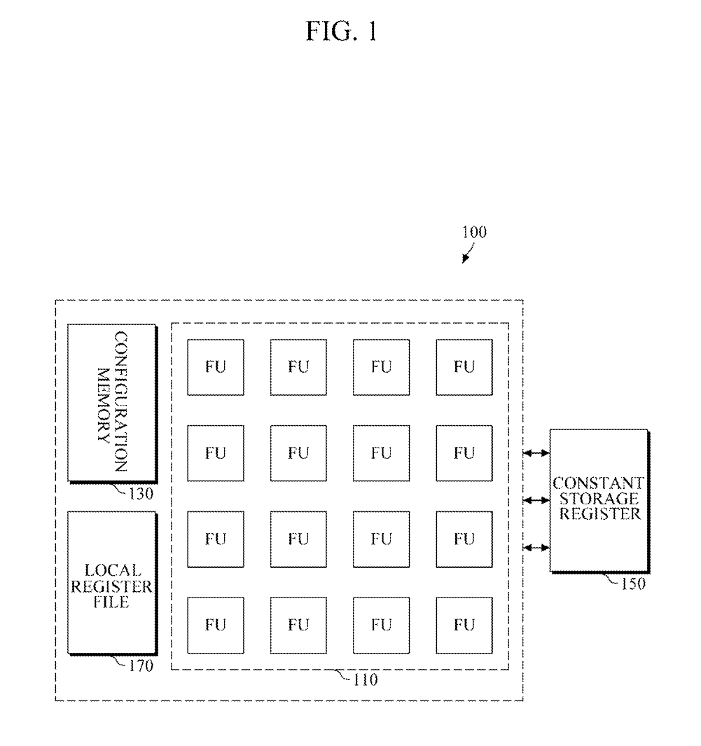

FIG. 1 is a configuration diagram illustrating a reconfigurable processor according to an exemplary embodiment.

Referring to FIG. 1, a reconfigurable processor 100 includes a plurality of Functional Units (FUs) 110, a configuration memory 130, a constant storage register 150 and a local register file 170.

The reconfigurable processor 100 may be a Coarse-Grained Array (CGA) processor.

A plurality of FUs 110 may process a specific task in parallel. Specifically, the FUs 110 may perform an integer arithmetic and logic unit (ALU) operation, multiplication and a load/store operation, respectively.

In addition, a plurality of FUs 110 may be connected to each other using multiple inputs and/or outputs, and the connection between the FUs may he changed at each cycle according to configuration information of the configuration memory 130.

The configuration memory 130 may store configuration information required to control operations of the reconfigurable processor 100.

Specifically, the configuration information stored in the configuration memory 130 may include an operation to be performed in each FU unit 110 at each cycle and information about interconnection between the FUs 110.

The configuration information in the configuration memory 130 may include an address of the constant storage register 150.

The constant storage register 150 may store a constant that is used as an operand for an operation performed in a plurality of FUs 110.

Specifically, the configuration information may include an address of the constant storage register 150 that stores constants which are scheduled to be used at different cycles. In addition, each of the FUs 110 may retrieve a constant necessary for an operation from the constant storage register 150 with reference to the address of the constant storage register 150, which is stored in the configuration memory 130.

According to an exemplary embodiment, the constant storage register 150 may store at least some constants able to be used for an application.

Specifically, the constant storage register 150 may store constants that are expected to be used for a specific number of times among all the constants required to execute an application. In this case, a constant to be stored in the constant storage register 150 may be determined by a compiler during a compiling process

In another exemplary embodiment, a constant to be stored in the constant storage register 150 may include a floating point constant.

The local register file 170 may store data required for an operation performed in the FU 110 and a result of the operation.

In addition, the local register file 170 may consist of one or more registers, and may be combined with each of the FUs 110, as opposed to what is shown FIG. 1.

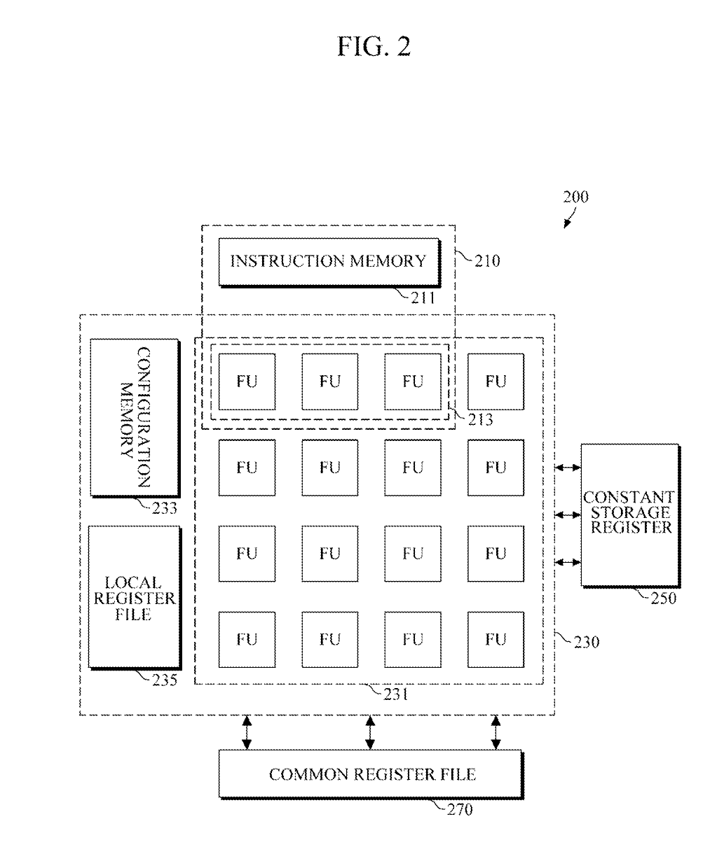

FIG. 2 is a configuration diagram illustrating a reconfigurable processor according to another exemplary embodiment.

Referring to FIG. 2, a reconfigurable processor 200 includes a host processor 210 and a Coarse-Grained Array (CGA) processor 230.

The reconfigurable processor 200 may operate in a first mode to perform general operations, except for loop operations, using the host processor 210, and operate in a second mode to perform loop operations using a CGA processor 230.

The host processor 210 may be a superscalar processor or a Very Long Instruction Word (VLIW) processor, but the exemplary embodiment is not limited thereto. That is, the host processor 210 may include various kinds of processors which are able to execute an instruction using an instruction set.

The host processor 210 may include one or more FUs, and may process a plurality of independently executable instructions in parallel using one or more FUs.

In one exemplary embodiment, the host processor 210 may use at least some of the FUs 231 of the CGA processor 230. An FU 213 is commonly used by the host processor 210 and the CGA processor 230 as follows: the FU 213 is used by the host processor 210 when the reconfigurable processor 200 operates in the first mode, and used but by the CGA processor 230 when the reconfigurable processor 200 operates in the second mode.

In another exemplary embodiment, the host processor 210 may include one or more additional FUs which are configured to be independent of the FUs 231 of the CGA processor 230.

The instruction memory 211 may provide instructions to be executed by the host processor 210. The host processor 210 may execute an instruction, stored in the instruction memory 211, using an instruction cache, an instruction fetch and an instruction decoder.

The instruction cache may be configured as a memory to store some of instructions stored in the instruction memory 211. If storing an instruction requested by the instruction fetch, the instruction cache may immediately transmit the stored instruction to the instruction cache, and, if not, fetches the instruction from an external memory and then transmits the fetched instruction to the instruction cache.

The host processor 210 may fetch, from the instruction cache, an instruction scheduled or expected to be executed, and interpret the fetched instruction to thereby generate an instruction of various kinds.

The CGA processor 230 may include a plurality of FUs 231, a configuration memory 233 and a local register file 235.

A plurality of FUs 231 may perform an integer arithmetic and logic unit (ALU) operation, multiplication and a load/store operation, respectively.

An operation performed by each FU 231 and interconnection between the FUs 231 may be changed at each cycle. In addition, an operation assigned to each FU 231 and interconnection between the FUs 231 may be stored in the configuration memory 233 as configuration information.

The constant storage register 250 may store an arbitrary constant necessary for an operation performed in the CGA processor 230.

If an operand necessary for an assigned operation is a constant, each FU 231 of the CGA processor 230 retrieves a constant from the constant storage register 250 with reference to an address of the constant storage register 250 that stores the constant, the address which is stored in the configuration memory 233.

Specifically, a constant used as an operand for an operation assigned to each FU 231 may be stored in the constant storage register 250, and the configuration memory 233 may store an address of the constant storage register 250 storing the constant.

Each FU 231 may access the constant storage register 250 using an address of the constant storage register 250 stored in the configuration memory 233.

That is, a plurality of FUs 231 do not use constants at every cycle and may use the same constant repetitively. Thus, if a constant to be used in each FU 231 at each cycle is stored in the configuration memory 233, a large capacity of the memory space may be assigned to store constants.

Accordingly, the configuration memory 233 may store not a constant itself, but an address of the constant storage register 250 that may store the constant, so that a memory space may be used more efficiently.

In one exemplary embodiment, the constant storage register 250 may store an arbitrary constant that is used as an operand for an operation performed in the host processor 210.

Specifically, the host processor 210 may perform a specific operation using a constant stored in the constant storage register 250. For example, the host processor 210 may execute an instruction indicating branch, shuffle, or jump using a constant stored in the constant storage register 250.

That is, the constant storage register 250 may be used as a register not just for a constant used in the second mode where the CGA processor 230 is able to operate, but for a constant used in the first mode where the host processor 210 is able to operate. In this manner, register pressure may be reduced.

In one exemplary embodiment, a constant stored in the constant storage register 250 may include a floating point constant.

In another exemplary embodiment, the constant storage register 250 may store a constant that is expected to be used a specific number of times among all the constants required to execute an application. In this case, a constant to be stored in the constant storage register 250 may be determined by a compiler during a compiling process.

The common register file 270 is designed for data transfer between the host processor 210 and the CGA processor 230.

In FIG. 2, before the reconfigurable processor 200 is shifted from the first mode into the second mode, the host processor 210 stores data (Live-in data) necessary for the CGA processor 230 in the common register file 270 so as to be transferred to the CGA processor 230.

In addition, if a loop operation ends when the reconfiguring processor 200 is operating in the second mode, the CGA processor 230 may transfer a result of the loop operation to the host processor 210 by storing the result in the common register file 270.

The local register file 235 may store data necessary for an operation performed in each FU 210, and operation results.

In addition, the local register file 235 may consist of one or more registers, and may be combined with each FU 231, as opposed to what is shown in FIG. 2.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A reconfigurable processor comprising:
a plurality of Functional Units (FUs);
a configuration memory configured to store configuration information; and
a constant storage register configured to store a constant that is used as an operand for an operation in the plurality of FUs.

2. The reconfigurable processor of claim 1, wherein the configuration information comprises address information of the constant storage register.

3. The reconfigurable processor of claim 1, wherein the constant comprises a floating point constant.

4. The reconfigurable processor of claim 1, wherein the constant storage register is further configured to store a second constant that is used for a predetermined number of times among constants required to execute an application.

5. A reconfigurable processor comprising:
a Coarse Grained Array (CGA) processor configured to process loop operations;
a host processor configured to process operations except for the loop operations; and
a constant storage register configured to store a constant that is used as an operand for an operation performed in at least one of the CGA processor and the host processor.

6. The reconfigurable processor of claim 5, wherein the CGA processor comprises:
a plurality of Functional Units (FUs); and
a configuration memory configured to store configuration information.

7. The reconfigurable processor of claim 5, wherein the host processor is a Very Long Instruction Word (VLIW) processor.

8. The reconfigurable processor of claim 5, wherein the configuration information comprises address information of the constant storage register.

9. The reconfigurable processor of claim 5, wherein the constant comprises a floating point constant.

10. The reconfigurable processor of claim 5, wherein the constant storage register is further configured to store a second constant that is used for a predetermined number of times among constants required to execute an application.

11. A reconfigurable processor comprising:
at least one Functional Unit (FU) configured to perform an operation using a constant;
a constant storage register configured to store the constant used by the at least one FU to perform the operation; and
a configuration memory configured to store an address of the constant storage register.

12. The reconfigurable processor of claim 11, wherein the at least one FU is further configured to retrieve the constant used for the operation from the constant storage register by referencing to the address of the constant storage register that is stored in the configuration memory.

13. The reconfigurable processor of claim 11, further comprising:
a host processor comprising the at least one FU and an instruction memory and configured to operate in a first mode to perform general operations; and
a Coarse-Grained Array (CGA) processor comprising the at least one FU and the configuration memory and configured to operate in a second mode to perform loop operations.

14. The reconfigurable processor of claim 13, wherein the constant storage register and stored constants are used by the host processor in the first mode and by the CGA processor in the second mode.

15. The reconfigurable processor of claim 11,
wherein the constant stored in the constant storage register is determined by a compiler during a compiling process; and
wherein the constant is scheduled to be used at a specific cycle and includes a floating point constant.

16. The reconfigurable processor of claim 13, further comprising:
a common register file configured to store data,
wherein, before the reconfigurable processor shifts from the first mode into the second mode, the host processor stores the data for the CGA processor in the common register file so as to be transferred to the CGA processor.

17. The reconfigurable processor of claim 11, the reconfigurable processor further comprising:
a local register file configured to store data used for the operation performed in the at least one FU, and operation results.
